(19) United States
(12) Patent Application Publication
(10) Pub. No.: US 2011/0173533 A1
(43) Pub. Date: Jul. 14, 2011

(54) Touch Operation Method and Operation Method of Electronic Device

(75) Inventors: Chun-Ting LIU, Hsin-Chu (TW); Kuang-Yu Fu, Hsin-Chu (TW); Ming-Yong Jou, Hsin-Chu (TW)

(73) Assignee: AU Optronics Corp.

(21) Appl. No.: 12/684,913

(22) Filed: Jan. 9, 2010

(51) Int. Cl. G06F 3/041; G06F 3/048

(52) U.S. Cl. 715/702; 715/822

(57) ABSTRACT

A touch operation method and an operation method of an electronic device are provided. The touch operation method comprises judging whether an await-selection object displayed on a touch screen is touched; outputting a floating menu corresponding to an attribute of the await-selection object when a touch time period of touching the await-selection object lasts for a first predetermined time period; judging whether one of a plurality of menu fields in the floating menu is selected, and performing a first instruction corresponding to the selected menu field when one of the menu fields in the floating menu is selected; and performing a second instruction corresponding to the selected menu field when a touch time period of selecting the selected menu field lasts for a second predetermined time period.

### CROSS-REFERENCE TO RELATED APPLICATIONS

This application is based upon and claims the benefit of priority from the prior Taiwanese Patent Application No. 098120269, filed Jun. 17, 2009, the entire contents of which are incorporated herein by reference.

### BACKGROUND

1. Field of the Invention

The present invention relates to an operation method of a touch screen, and more particularly to a touch operation method and an operation method of an electronic device.

2. Description of the Related Art

In the market of various consumable electronic products, touch panels have been widely applied into various portable electronic products, such as personal digital assistant (PDA), mobile phone, notebook computer and tablet computer, etc., to be used as an interface tool for communicating data. In addition, the current electronic products are designed to be more light, thin, short and small, thus the electronic products have no enough space to contain conventional input devices, such as keyboard or mouse, etc. More particularly to the tablet computer with the humanized design, the touch panels have been a crucial component. Furthermore, the touch panels further have many humanized operation modes, such as the functions of the keyboard or the mouse, and the handwriting input, etc., except displaying multi-level menus. More particularly, the touch panels can integrate the input function and the output function into a same interface (screen), which cannot be performed by the conventional input devices.

In conventional touch screens, when users operate files in the electronic devices, they may perform a selection in a menu displayed on the touch screens or employ hardware operating-keys on the electronic devices to perform relative operations. Thus, the conventional touch screens only can list a common connatural function menu of general documents or files, and cannot display different function menus according to the different attributes of the documents or the files. When the users operate the touch screens, they should switch the menus and the objects reiteratively. Thus if touching wrongly in the process, the relative operation even may be performed again.

To solve the above problem, a U.S. Pat. No. 7,479,949 discloses an operation method of a touch screen. The operation method of the touch screen employs a single-dot or multi-dots touching mode to operate the touch screen. For the multi-dots touching mode, the users can employ moving tracks of two fingers on the touch screen to zoom in and zoom out pictures displayed on the touch screen. For the single-dot touching mode, the users can employ a left-moving of a finger to view the files in a previous-page or employ a right-moving of a finger to view the files in the previous-page. The above operation method is convenient in use, but the users must remember a plurality of operation gestures in advance. Furthermore, when the electronic devices judge the operation gestures, they may misjudge the operation gestures because the strength of touching the objects is not enough or the direction thereof is deviated, thus the users must perform the operation gestures again.

### BRIEF SUMMARY

The present invention relates to a touch operation method, which outputs a floating menu when a touch screen is touched, such that users can easily operates the touch screen to reduce wrong operations of giving gestures.

The present invention also relates to an operation method of an electronic device, which make users smoothly operate the electronic device without remembering operation gestures of the electronic device, to effectually improve a convenience of a touch screen.

A touch operation method in accordance with an exemplary embodiment of the present invention is adapted for a touch screen. The touch operation method comprises judging whether an await-selection object displayed on the touch screen is touched; outputting a floating menu corresponding to an attribute of the await-selection object when a touch time period of touching the await-selection object lasts for a first determined time period; judging whether one of a plurality of menu fields in the floating menu is selected, and performing a first instruction corresponding to the selected menu field when one of the menu fields in the floating menu is selected; and performing a second instruction corresponding to the selected menu field when a touch time period of selecting the selected menu field lasts for a second predetermined time period.

In an exemplary embodiment of the present invention, the step of outputting the floating menu comprises outputting the floating menu on the basis of a touch point of touching the await-selection object.

In an exemplary embodiment of the present invention, the step of performing the second instruction corresponding to the selected menu field when the touch time period of selecting the selected menu field lasts for the second predetermined time period, comprises judging whether the selected menu field is still uninterruptedly selected after the touch time period of selecting the selected menu field lasts for the second predetermined time period; and repeating the second instruction every a predetermined time interval when the selected menu field is still uninterruptedly selected.

An operation method of an electronic device in accordance with another exemplary embodiment of the present invention is provided. The electronic device comprises a touch screen, and the touch screen displays at least one await-selection object. The operation method of the electronic device comprises outputting a floating menu corresponding to an attribute of the await-selection object when a touch time period of touching the await-selection object lasts for a first predetermined time period; performing a first instruction corresponding to a selected menu field when a touch time period of selecting one of a plurality of menu fields in the floating menu does not last for a second predetermined time period, and performing a second instruction corresponding to the selected menu field when the touch time period of selecting the selected menu field lasts for the second predetermined time period. The first predetermined time period is less than the second predetermined time period.

The present invention outputs the floating menu when the touch screen is touched, thus the users can easily operate the electronic device without remembering the operation gestures of the electronic device. Therefore the present invention not only can reduce the wrong operations of giving the operation gestures, but also can effectually improve the using convenience of the touch screen.

### BRIEF DESCRIPTION OF THE DRAWINGS

These and other features and advantages of the various embodiments disclosed herein will be better understood with respect to the following description and drawings, in which like numbers refer to like parts throughout, and in which:

FIGS. 1A and 1B together is a flow chart of a touch operation method in accordance with an exemplary embodiment of the present invention.

FIG. 2 is a flow chart of judging whether an await-selection object is touched in the touch operation method in accordance with an exemplary embodiment of the present invention.

FIG. 3A is a schematic view of outputting a floating menu on a touch screen in accordance with an exemplary embodiment of the present invention.

FIG. 3B is a schematic view of selecting a menu field in the floating menu and performing a corresponding instruction in accordance with an exemplary embodiment of the present invention.

FIG. 4A is a schematic view of outputting a plurality of await-selection objects in a touch screen in accordance with another exemplary embodiment of the present invention.

FIG. 4B is a schematic view of displaying a floating menu on the touch screen in accordance with another exemplary embodiment of the present invention.

FIG. 4C is a schematic view of performing an instruction corresponding to a selected menu field in accordance with another exemplary embodiment of the present invention.

FIG. 4D is a schematic view of performing another instruction corresponding to the selected menu field in accordance with another exemplary embodiment of the present invention.

### DETAILED DESCRIPTION

Reference will now be made to the drawings to describe exemplary embodiments of the present touch operation method and the present operation method of the electronic device, in detail. The following description is given by way of example, and not limitation.

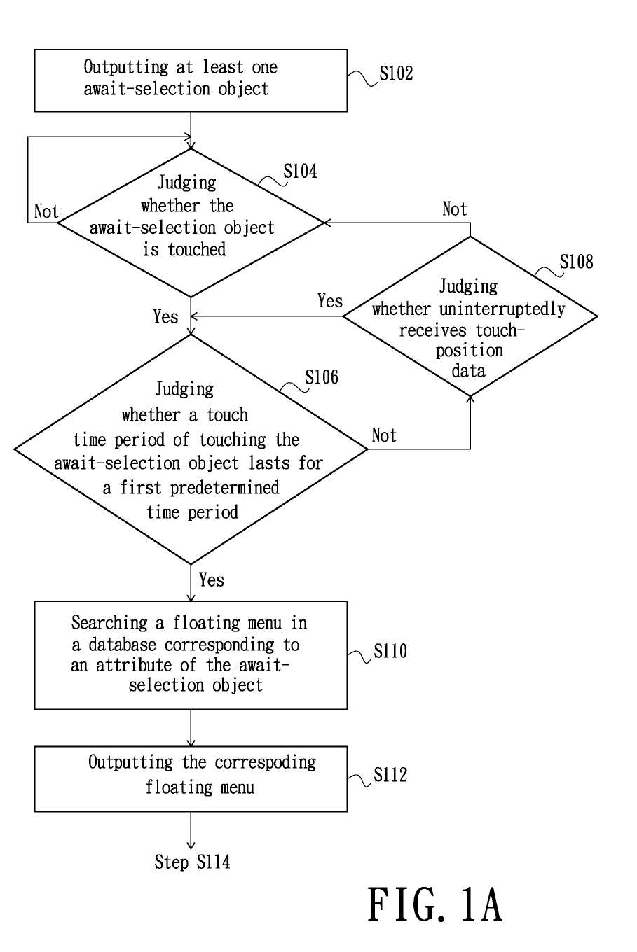

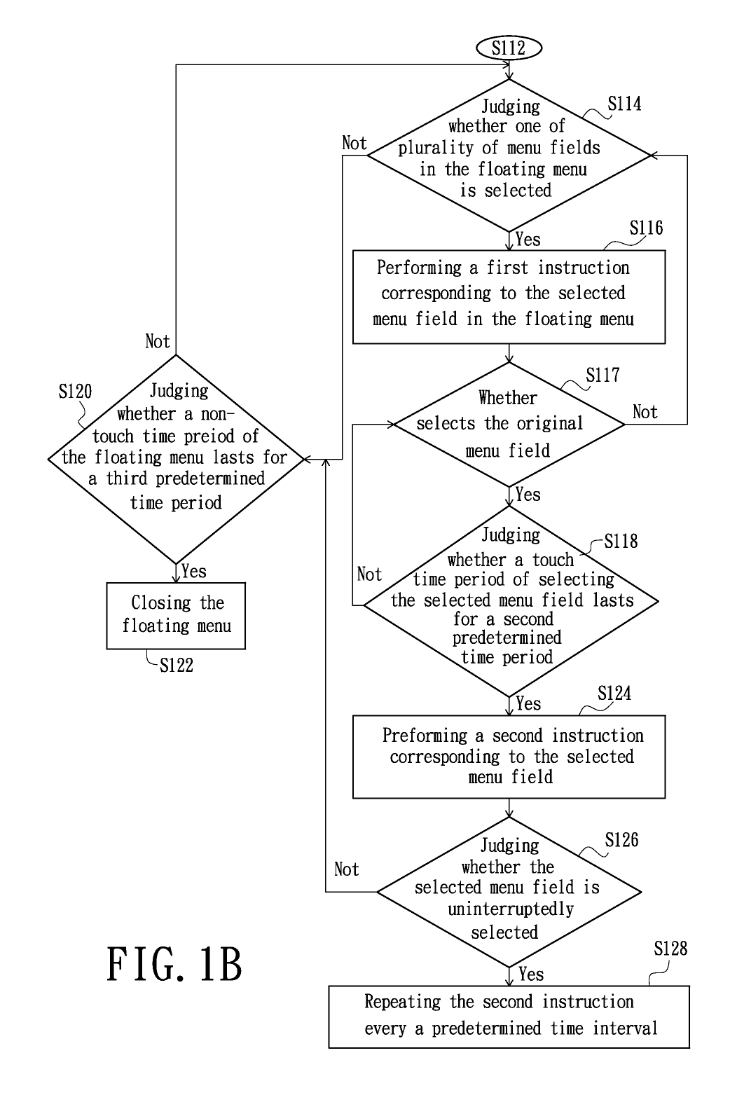

Please refer to FIGS. 1A and 1B, either of which is part of a flow chart of a touch operation method in accordance with an exemplary embodiment of the present invention. In this exemplary embodiment, the touch operation method is adapted for a touch screen of an electronic device. When the electronic device is enabled, the electronic device displays at least one await-selection object on the touch screen (a step S102). Alternatively, when users touch anywhere on the touch screen, the touch screen displays at least one await-selection object. Alternatively, the electronic device or the touch screen has a specific function-key thereon, and when the function-key is pressed, the touch screen displays at least one await-selection object. Of course, modes for displaying the await-selection object are not limited in the present invention.

In an exemplary embodiment of the present invention, the await-selection object may be a photo, a video file, a document file, an email, or other file which may be freely viewed or edited by the users.

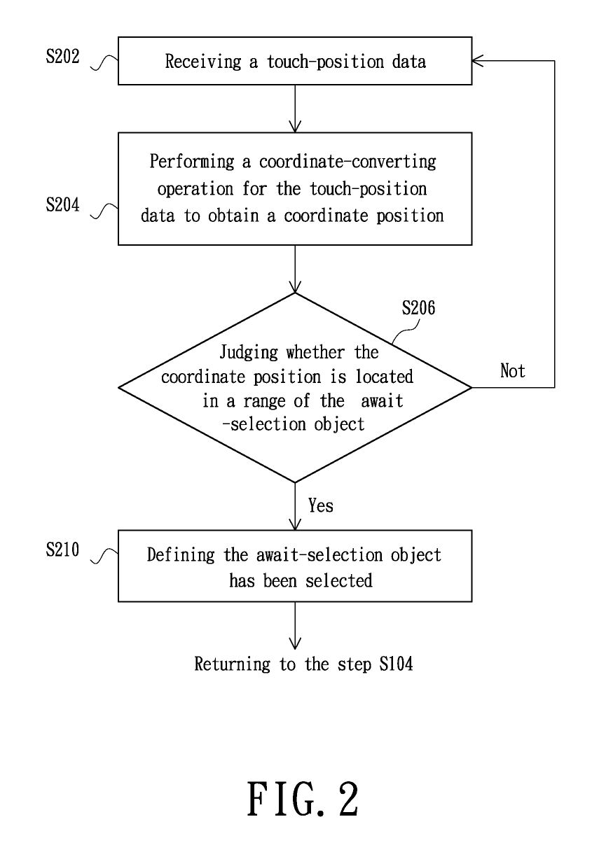

In this exemplary embodiment, when the await-selection object is outputted to the touch screen, the electronic device judges whether the await-selection object is touched (a step S104). Please refer to FIG. 2, which is a flow chart of judging whether the await-selection object is touched in the touch operation method in accordance with an exemplary embodiment of the present invention. In FIG. 2, after the electronic device receives a touch-position data (a step S202), a coordinate-converting operation is performed for the touch-position data (a step S204). Wherein, display images of the touch screen themselves have a predefined coordinate standard therein, thus the electronic device can convert the touch-position data into a corresponding coordinate position of a touch point according to the predefined coordinate standard. The await-selection object displayed on the touch screen has a range, for example, a quadrangular await-selection object has four coordinate positions representing its range. Therefore, after the electronic device obtains the coordinate position of the touch point, it will compare the coordinate position of the touch point with the range of each of await-selection objects, to judge which of the range of the await-selection objects is the coordinate position of the touch point located in (a step S206).

When the coordinate position of the touch point is located in a range of an await-selection object, the electronic device defines the await-selection object is selected by the users (a step S210) and returns to the step S104. On the contrary, when the coordinate position of the touch point is not located in the range of any of the await-selection objects, the electronic device defines the users do not select any of the await-selection object and returns to the step S202.

Referring to FIG. 1 again, when the await-selection object is selected, the electronic device will then judge whether a touch time period of the users touching the await-selection object lasts for a first predetermined time period (a step S106). This judgment can be performed by judging whether the coordinate position of the touch point is always located in the range of the same await-selection object. When judging the touch time period of touching the await-selection object does not last for the first predetermined time period, the touch operation method will judge whether the electronic device uninterruptedly receives the touch-position data (a step S108). That is, after the touch-position data are converted into coordinate positions, the touch operation method will judge whether the coordinate positions are all located in the range of the same await-selection object. When judging the continuously received touch-position data are all located in the range of the same await-selection object, it defines the electronic device uninterruptedly receives the touch-position data and returns the step S106. On the contrary, when the touch-position data are located in ranges of different await-selection objects, it returns the step S104.

In this exemplary embodiment, after determining the touched await-selection object, the touch operation method will search a floating menu corresponding to the await-selection object in a database of the electronic device according to an attribute of the await-selection object (a step S110). The await-selection objects with different attributes have different floating menus. For example, comparing photo files with video files, the photo files have functions of zooming in, zooming out and rotating, and the video files do not have those functions. On the contrary, the video files have functions of playing, fast-forwarding and rewinding, and the photo files do not have those functions.

After searching the corresponding floating menu, the electronic device outputs the floating menu to the touch screen (a step S112). A mode for outputting the floating menu may be outputting the floating menu on the basis of a touch point of touching the await-selection object, and outputting the floating menu to a central position of the touch screen or outputting menu fields in the floating menu to different corners of the touch screen. The floating menu generally comprises a plurality of menu fields. Then the electronic device judges which of the menu fields in the floating menu is selected (a step S114).

In the step S114, a method may be regarding the touch point as an original point when outputting the floating menu, and only applying lateral stresses on the original point to select different menu fields without employing the finger of the users to touch the menu fields. For example, initially the position of the original point is a central position of the floating menu, that is, a central menu field in the center of the floating menu (which may be indicated by reversed out, to make the users know the current position). When the stress applied to the original point is judged to be a later stress which an applied-stress direction thereof is towards a lower edge of an image, the electronic device determines the menu field selected by the users is a menu field below the central menu field (which one of the menu fields below the central menu field is determined by an existent time of the lateral stress and how often does the electronic device judge). Therefore, the users can employ the lateral stresses with the various directions to select different menu fields. When the electronic device detects the lateral stress of the original point, the later stress performs a direction-index operation to obtain a direction index. Then a corresponding menu field is defined as the selected menu field according to the direction of the direction index and the length of the pressed time period.

When determining the selected menu field in the step S114, the electronic device performs a corresponding first instruction according to the function represented by the selected menu field (a step S116). Secondly, the operation method judges whether the original menu field is selected (a step S117). That is, the electronic device judges whether the users continuously select the same menu field. When the users continuously select the same menu field, the electronic device will further judge whether a touch time period of selecting the selected menu field lasts for a second predetermined time period (a step S118).

The step of judging whether the original menu field is selected may be performing the coordinate-converting operation for the touch-position data after the electronic device receives the touch-position data to obtain the coordinate position of the current touch point. Then the operation method judges whether the coordinate position of the current touch point is located in the range of the menu field which has performed the first instruction. When judging the coordinate position of the current touch point is located in the range of the menu field which has performed the first instruction, it defines the original menu field is continuously selected. In addition, when the coordinate position of the current touch point is not located in the range of the menu field which has performed the first instruction, the electronic device only performs the first instruction and returns the step S114. When the floating menu is not touched and a non-touch time period thereof lasts for a third predetermined time period, it will close the floating menu (a step S122) and return the step S104. On the contrary, when the non-touch time period of not touching the floating menu does not last for the third predetermined time period, it will returns the step S114 and judges whether having a menu field which is selected. If no menu field is selected, the step S120 is performed.

In this exemplary embodiment, when the touch time period of selecting the selected menu field lasts for the second predetermined time period, the electronic device performs a second instruction corresponding to the selected menu field. The first instruction may be same to the second instruction, or different with the second instruction, which is determined by needs of designers.

After performing the second instruction, the electronic device uninterruptedly judges whether the selected menu field is continuously selected (a step S126). The judging mode is performing the coordinate-converting operation for the touch-position data after the electronic device receives the touch-position data to obtain the coordinate position of the current touch point. Then the operation method judges whether the coordinate position of the current touch point is located in the range of the selected menu field. When judging the coordinate position of the current touch point is located in the range of the selected menu field, the second instruction is repeated every a predetermined time interval. On the contrary, when the selected menu field is not continuously selected, the step S120 is performed.

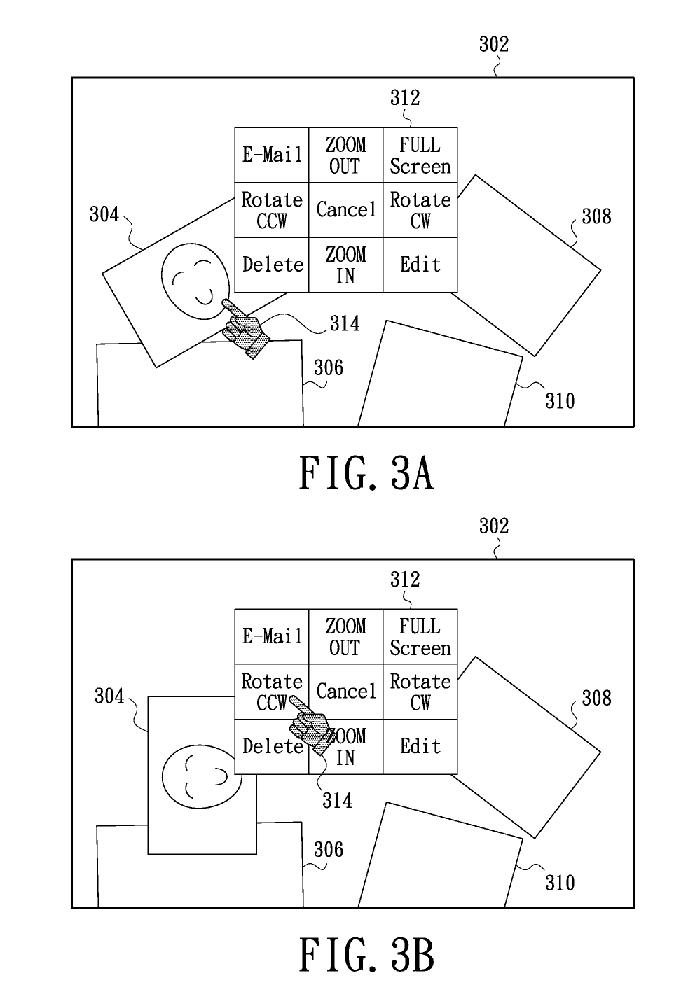

Please refer to FIGS. 3A and 3B, which are a schematic view of a floating menu displayed on a touch screen in accordance with an exemplary embodiment of the present invention, and a schematic view of selecting a menu field of the floating menu and performing a corresponding instruction in accordance with an exemplary embodiment of the present invention. In FIG. 3A, the touch screen 302 displays await-selection objects 304˜310 and a floating menu 312. After a finger 314 on the touch screen 302 touches the await-selection object 304, the electronic device performs the steps S104˜S112 as shown in FIG. 1 to display the floating menu 312 on the touch screen 302. The floating menu 312 has a plurality of menu fields, such as email, zoom out, full screen, anticlockwise rotate (rotate CCW), cancel, clockwise rotate (rotate CW), delete, zoom in and edit.

Referring to FIG. 3B continuously, when the finger 314 touches the menu field of anticlockwise rotate, the electronic device performs the step S116 as shown in FIG. 1 to anticlockwise rotate the menu field. When the finger 314 continuously touches the menu field of anticlockwise rotate, and a touch time period thereof lasts for the second predetermined time period, the electronic device performs the step S124 as shown in FIG. 1. The first instruction may anticlockwise rotate the await-selection object 304 with 45 degrees, and the second instruction also may anticlockwise rotate the await-selection object 304 with 45 degrees or 1 degree. When the touch time period of the finger 314 touching the menu field of anticlockwise rotate lasts for the second predetermined time period, the electronic device may anticlockwise rotate the await-selection object 304 with 45 degrees or 1 degree every 0.5 second until the finger 314 removes from the touch screen 302, but the present invention does not limit in this.

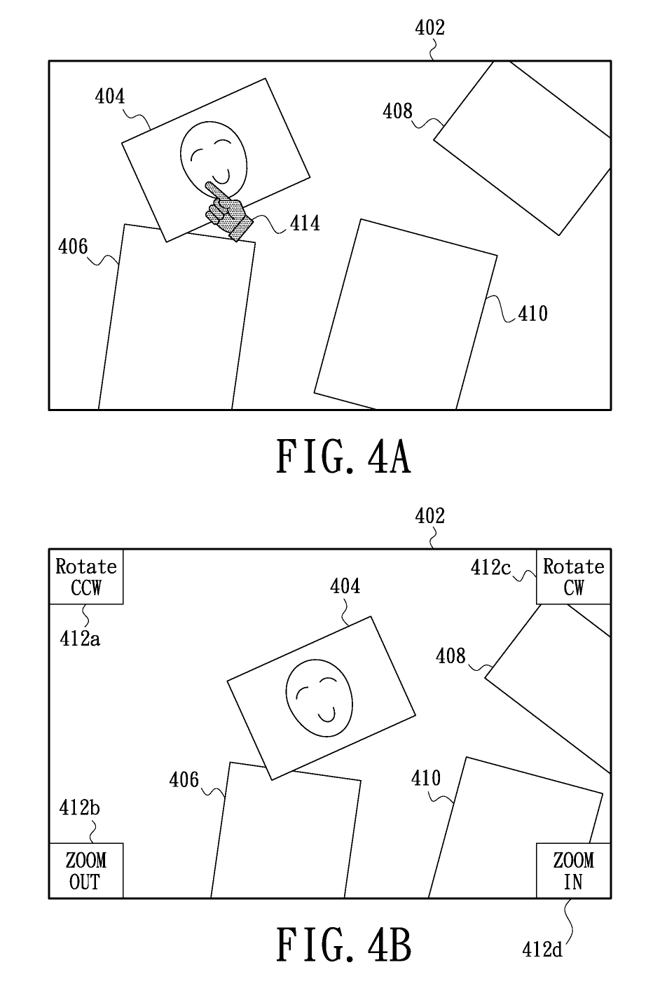

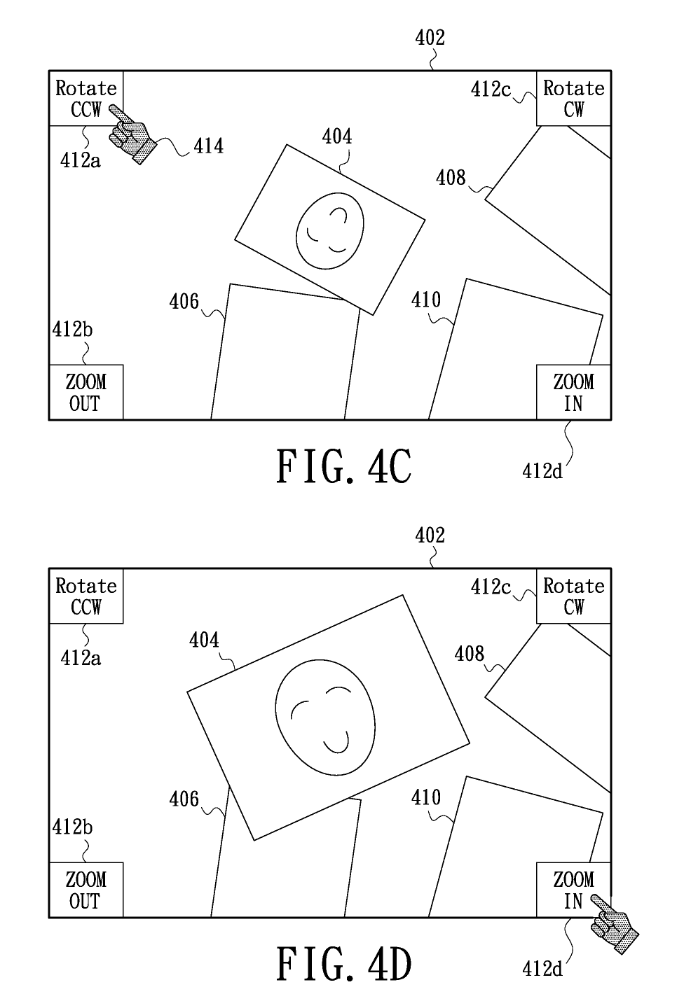

Please refer to FIGS. 4A˜4D, which are a schematic view of a plurality of await-selection objects outputted on a touch screen in accordance with another exemplary embodiment of the present invention, a schematic view of a floating menu displayed on the touch screen in accordance with another exemplary embodiment of the present invention, a schematic view of performing an instruction corresponding to a menu field in accordance with another exemplary embodiment of the present invention, and a schematic view of performing another instruction corresponding to the menu field in accordance with another exemplary embodiment of the present invention respectively. In FIG. 4A, the touch screen 402 has await-selection objects 404˜410 and a finger 414. When the finger 414 touches the await-selection object 404, the electronic device divides the floating menu of FIG. 3A, and outputs menu fields 412a˜412d to four corners of the touch screen 402 respectively (as shown in FIG. 4B). For describing conveniently, the exemplary embodiment uses the four menu fields 412a˜412d as an example, but the present invention is not limited in this.

In this exemplary embodiment, when outputting the menu fields 412a˜412d, the electronic device moves the await-selection object 404 to a central position of the touch screen 402, and moves the await-selection objects 406˜410 to edges of the touch screen 402. This is only an exemplary embodiment of the present invention, but is still determined by the needs of the designers in actual.

In FIG. 4C, when the finger 414 touches the menu field 412a (the menu field of anticlockwise rotate), the electronic device performs the step S116 as shown in FIG. 1 to anticlockwise rotate the await-selection object 404. When the finger 414 continuously touches the menu field 412a and a touch time period thereof lasts for the second predetermined time period, the electronic device performs the step S124 as shown in FIG. 1. After the touch time period of the finger 414 touching the menu field 412a lasts for the second predetermined time period, the electronic device performs the step S128 as shown in FIG. 1.

In FIG. 4D, when the finger 414 touches the menu field 412d (the menu field of zoom in), the electronic device performs the step S116 as shown in FIG. 1 to zoom in the await-selection object 404. When the finger 414 continuously touches the menu field 412a and the touch time period thereof lasts for the second predetermined time period, the electronic device performs the step S124 as shown in FIG. 1. After the touch time period of the finger 414 touching the menu field 412a lasts for the second predetermined time period, the electronic device performs the step S128 as shown in FIG. 1.

In summary, the touch operation method and the operation method of the electronic device of the present invention output a floating menu when the touch screen is touched. Thus the users can easily operate the electronic device without remembering the operation gestures of the electronic device. Therefore, the touch operation method and the operation method of the electronic device not only can reduce the wrong operations of giving the operation gestures, but also can improve the using convenience of the touch screen.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A touch operation method adapted for a touch screen, comprising:
judging whether an await-selection object displayed on the touch screen is touched;
when a touch time period of touching the await-selection object lasts for a first predetermined time period, outputting a floating menu corresponding to an attribute of the await-selection object;
judging whether one of a plurality of menu fields in the floating menu is selected;
when one of the menu fields in the floating menu is selected, performing a first instruction corresponding to the selected menu field; and
when a touch time period of selecting the selected menu field lasts for a second predetermined time period, performing a second instruction corresponding to the selected menu field.

2. The touch operation method as claimed in claim 1, wherein the step of judging whether the await-selection object is touched, comprises:
receiving a touch-position data;
performing a coordinate-converting operation for the touch-position data to obtain a coordinate position;
judging whether the coordinate position is located in a range of the await-selection object; and
when the coordinate position is located in the range of the await-selection object, defining the await-selection object is selected.

3. The touch operation method as claimed in claim 2, further comprising:
when the touch time period of touching the await-selection object does not lasts for the first predetermined time period, judging whether uninterruptedly receives the touch-position data;
when not receiving the touch-position data, judging whether the await-selection object is touched; and
when uninterruptedly receiving the touch-position data, judging whether the touch time period of touching the await-selection object lasts for the first predetermined time period.

4. The touch operation method as claimed in claim 1, wherein the floating menu is outputted on the basis of a touch dot of touching the await-selection object.

5. The touch operation method as claimed in claim 4, wherein the step of judging whether one of the menu fields in the floating menu is selected, comprises:
detecting a lateral stress of the touch point;
performing a direction-index operation for the lateral stress, to obtain a direction index; and
defining a corresponding one of the menu fields as the selected menu field according to the direction index.

6. The touch operation method as claimed in claim 5, wherein the step of performing the second instruction corresponding to the selected menu field when the touch time period of selecting the selected menu field lasts for the second predetermined time period, comprises:
judging whether the selected menu field is still uninterruptedly selected after the touch time period of selecting the selected menu field lasts for the second predetermined time period; and
when the selected menu field is still uninterruptedly selected, repeating the second instruction every a predetermined time interval.

7. The touch operation method as claimed in claim 1, wherein the step of judging whether one of the menu fields in the floating menu is selected, comprises:
detecting a lateral stress of the touch point;
performing a direction-index operation for the lateral stress, to obtain a direction index; and
defining a corresponding one of the menu fields as the selected menu field according to the direction index.

8. The touch operation method as claimed in claim 7, wherein when another await-selection object in the touch screen is touched, the floating menu is closed.

9. The touch operation method as claimed in claim 7, wherein the step of performing the second instruction corresponding to the selected menu field when the touch time period of selecting the selected menu field lasts for the second predetermined time period, comprises:
judging whether the selected menu field is still uninterruptedly selected after the touch time period of selecting the selected menu field lasts for the second predetermined time period; and
when the selected menu field is still uninterruptedly selected, repeating the second instruction every a predetermined time interval.

10. The touch operation method as claimed in claim 9, further comprising:
when all of the menu fields are not selected, judging whether a non-touch time period of not selecting all of the menu fields lasts for a third predetermined time period; and
when the non-touch time period of not selecting all of the menu fields lasts for the third predetermined time period, closing the floating menu.

11. The touch operation method as claimed in claim 1, wherein the floating menu is outputted to a central position of the touch screen.

12. The touch operation method as claimed in claim 1, wherein the menu fields are outputted to corners of the touch screen.

13. An operation method of an electronic device, the electronic device comprising a touch screen, the touch screen displaying at least one await-selection object, and the operation method of the electronic device comprising:
when a touch time period of touching the await-selection object lasts for a first predetermined time period, outputting a floating menu corresponding to an attribute of the await-selection object; and
when a touch time period of selecting one of a plurality of menu fields in the floating menu does not last for a second predetermined time period, performing a first instruction corresponding to the selected menu field; and when the touch time period of selecting the selected menu field lasts for the second predetermined time period, performing a second instruction corresponding to the selected menu field;
wherein the first predetermined time period is less than the second predetermined time period.

14. The operation method of the electronic device as claimed in claim 13, further comprising judging whether one of the menu fields in the floating menu is selected.

15. The operation method of the electronic device as claimed in claim 14, wherein the floating menu is outputted on the basis of a touch point of touching the await-selecting object.

16. The operation method of the electronic device as claimed in claim 15, wherein the step of judging whether one of the menu fields in the floating menu is selected, comprises:
detecting a lateral stress of the touch point;
performing a direction-index operation for the lateral stress, to obtain a direction index; and
defining a corresponding one of the menu fields as the selected menu field according to the direction index.

17. The operation method of the electronic device as claimed in claim 16, wherein the step of performing the second instruction corresponding to the selected menu field when the touch time period of selecting the selected menu field lasts for the second predetermined time period, comprises:
judging whether the selected menu field is still uninterruptedly selected after the touch time period of selecting the selected menu field lasts for the second predetermined time period; and
when the selected menu field is still uninterruptedly selected, repeating the second instruction every a predetermined time interval.

18. The operation method of the electronic device as claimed in claim 13, wherein the step of judging whether one of the menu fields in the floating menu is selected, comprises:
detecting a lateral stress of the touch point;
performing a direction-index operation for the lateral stress, to obtain a direction index; and
defining a corresponding one of the menu fields as the selected menu field according to the direction index.

19. The operation method of the electronic device as claimed in claim 18, wherein when another await-selection object on the touch screen is touched, the floating menu is closed.

20. The operation method of the electronic device as claimed in claim 19, wherein the step of performing the second instruction corresponding to the selected menu field when the touch time period of selecting the selected menu field lasts for the second predetermined time period, comprises:
judging whether the selected menu field is still uninterruptedly selected after the touch time period of the selected menu field lasts for the second predetermined time period; and
when the selected menu field is still uninterruptedly selected, repeating the second instruction every a predetermined time interval.

21. The operation method of the electronic device as claimed in claim 20, further comprising:
when all of the menu fields are not selected, judging whether a non-touch time period of not selecting all of the menu fields lasts for a third predetermined time period; and
when the non-touch time period of the not selecting all of the menu fields lasts for the third predetermined time period, closing the floating menu.

22. The operation method of the electronic device as claimed in claim 13, wherein the floating menu is outputted to a central position of the touch screen.

23. The operation method of the electronic device as claimed in claim 13, wherein the menu fields are distributed at corners of the touch screen.
